(19) United States
(12) Patent Application Publication
(10) Pub. No.: US 2007/0000548 A1
(43) Pub. Date: Jan. 4, 2007

(54) Method and device for producing microparticles in a continuous phase liquid

(75) Inventors: Gwo-Bin Lee, Tainan City (TW); Cheng-Tso Chen, Tainan City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NATIONAL CHENG KUNG UNIVERSITY, Tainan City (TW)

(21) Appl. No.: 11/338,193

(22) Filed: Jan. 23, 2006

(30) Foreign Application Priority Data
Jun. 29, 2005 (TW) 94121782

(51) Int. Cl. F15C 1/08

(52) U.S. Cl. 137/830

(57) ABSTRACT

A continuous phase liquid and a dispersed phase liquid are permitted to flow together through a co-flow channel. Preferably, the dispersed phase liquid is arranged to flow within the flowing body of the continuous phase liquid in the co-flow channel. The continuous phase and dispersed phase liquids are comminuted intermittently by intermittently moving a comminuting member transversely into the co-flow channel, thereby producing microparticles of the dispersed phase liquid. A chip device for producing the microparticles is also disclosed.

### CROSS-REFERENCE TO RELATED APPLICATION

This application claims priority from Taiwanese Utility Application No. 94121782, filed on Jun. 29, 2005.

### BACKGROUND OF THE INVENTION

1. Field of the Invention

This invention relates to the production of microparticles, more particularly to a method and a chip device for producing microparticles of a dispersed phase liquid in a continuous phase liquid.

2. Description of the Related Art

Application of biotechnology has been widely extended to many industrial fields, such as cosmetic and food industries in addition to the manufacture of pharmaceutical products. For example, microparticles have been produced based on biotechnology for nutritious foods in order to improve absorption of the nutritious foods by human bodies. Many methods and apparatuses have been suggested in the art for the production of microparticles.

Referring to FIGS. 1, 2 and 3, U.S. Pat. No. 6,177,479 discloses an apparatus for producing microspheres, which includes a housing 10 and a forming unit 20. The housing 10 includes a receiving space 11, and first, second and third channels 12, 14 and 16 all of which are connected to the receiving space 11.

The forming unit 20 is rectangular and includes opposite first and second faces 21 and 22. The first face 21 is recessed to form a rectangular recess 210, and a through hole 23 extends through the center of the first and second faces 21, 22 and the center of the recess 210. A row of protrusions 251 are spaced apart by microgaps and are formed on one of sidewalls 25 which surrounds the rectangular recess 210. The first face 21 is placed in contact with a wall surface of the receiving space 11 so that the second channel 14 is communicated with the through hole 23 and the rectangular recess 210.

In use, a first liquid is introduced into the first channel 12, whereas a second liquid is directed to the second channel 14. The first liquid flows into and fills the receiving space 11, and the second liquid flows through the through hole 23. After the rectangular recess 210 is filled, the increasing pressure in the recess 210 due to the continued in flowing of the second liquid will cause the second liquid to squeeze through the microgaps of the protrusions 251, thereby forming microspheres which are then dispersed in the first liquid in the receiving space 11.

In the aforesaid system, a surfactant is added to the second liquid in order to stabilize the microspheres of the second liquid in the first liquid. However, the aforesaid system requires a high pressure to pressurize the second liquid in the rectangular recess 210 and a tight fluid seal between the forming unit 20 and the housing 10. Otherwise, the second liquid can flow through other gaps than the microgaps, resulting in non-uniform liquid particles and/or failure to form microspheres.

Furthermore, since the size of the microspheres depends on the size of the microgaps, it is impossible to vary the size of the microspheres once the microgaps have been designed and constructed.

Other examples of the microsphere production are disclosed in U.S. Pat. Nos. 6,258,858, 6,576,023, 6,155,710 and 6,387,301.

### SUMMARY OF THE INVENTION

An object of the present invention is to provide a chip device which overcomes the disadvantages encountered with the aforesaid prior art.

Another object of the present invention is to provide a simple method of producing liquid micorparticles.

Still another object of the present invention is to provide a chip device for use in the production of liquid microparticles.

According to one aspect of the present invention, a method of producing microparticles comprises: (a) allowing a continuous phase liquid and a dispersed phase liquid to flow together through a co-flow channel; and

(b) intermittently comminuting the continuous phase and dispersed phase liquids by intermittently moving a comminuting member transversely into the co-flow channel.

Preferably, the dispersed phase liquid is caused to flow within the flowing body of the continuous phase liquid in the co-flow channel. At least two streams of the continuous phase liquid may be provided to sandwich a stream of the dispersed phase liquid when the continuous phase and dispersed phase liquids enter the co-flow channel.

According to another aspect of the present invention, a chip device for producing microparticles comprises a co-flow channel adapted to permit a continuous phase liquid and a dispersed phase liquid to flow together therein and having an upstream end and a downstream end, and a plurality of microchannels adapted to direct the continuous phase liquid and the dispersed phase liquid to flow into the co-flow channel. All of the microchannels are connected to the up stream end of the co-flow channel. The chip device further includes a comminuting unit disposed transversely of the co-flow channel and operable to intermittently move into the co-flow channel in a direction transverse to the co-flow channel so that the continuous phase and dispersed phase liquids are comminuted.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a sectional view of a conventional apparatus for manufacturing microspheres;

FIG. 2 is a perspective view of a forming unit of the apparatus of FIG. 1;

FIG. 3 is a view showing the formation of microspheres using the forming unit;

FIG. 4 is an exploded view of a chip device according to a preferred embodiment of the present invention;

FIG. 5 is a plan view of the chip device of FIG. 4;

FIG. 6 is a schematic view showing a dispersed phase liquid flowing between two streams of a continuous phase liquid;

FIG. 7 is a fragmentary sectional view of the chip device of FIG. 4;

FIG. 7A is a schematic view showing a pressurizing channel unit of the chip device of FIG. 4;

FIG. 8 is the same view as FIG. 7 but showing that a dispersed phase is divided by a comminuting member;

FIG. 9 is the same view as FIG. 7 but showing that the comminuting member returns to its original position after comminuting the dispersed phase liquid;

FIG. 10 is an exploded view of a chip device according to another preferred embodiment of the present invention;

FIG. 11 is a plan view of the chip device of FIG. 10;

FIG. 12 is a fragmentary sectional view of the chip device of FIG. 10; and

FIGS. 13 and 14 are diagrams showing varying sizes of the microparticles produced in an example.

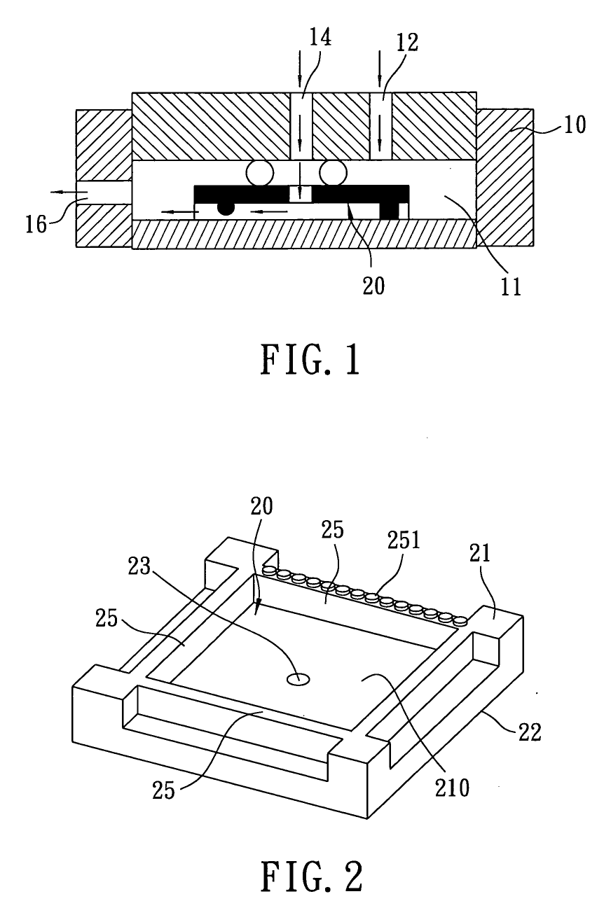

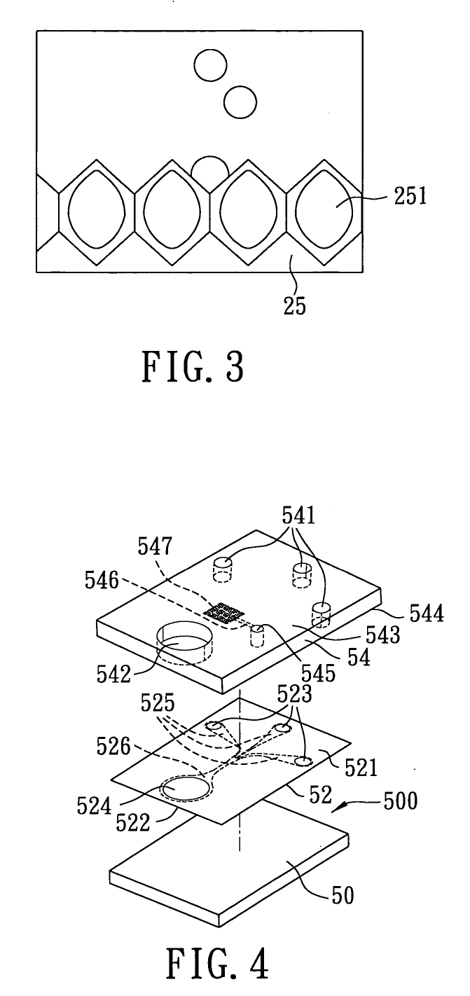

### DETAILED DESCRIPTION OF THE PREFERRED EMBODIMENTS

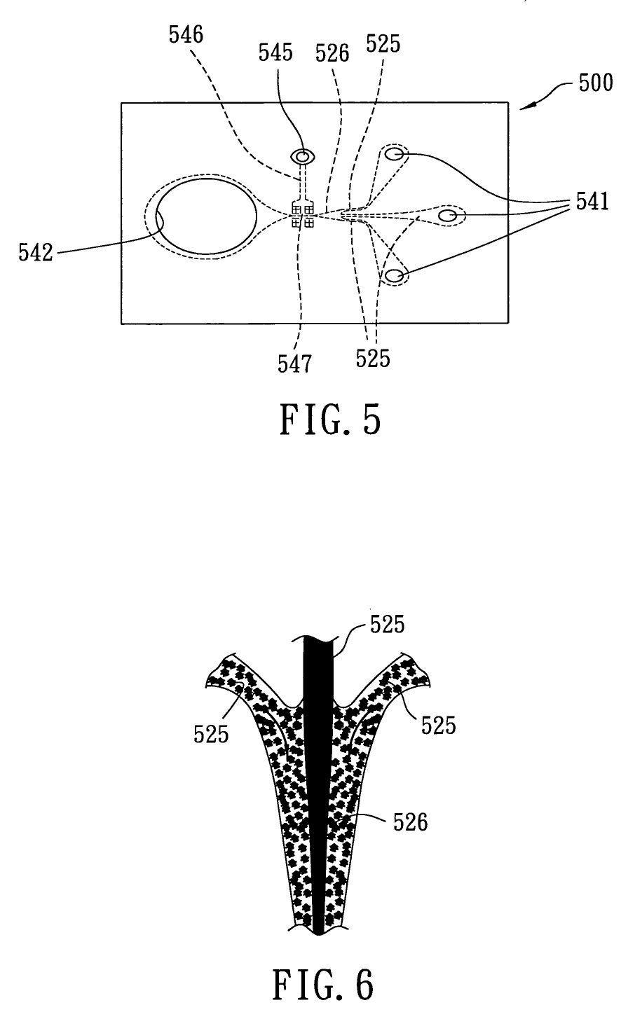

Referring to FIGS. 4 and 5, a chip device 500 embodying the present invention includes a substrate 50, a liquid bearing layer 52 and a pressure layer 54. In this embodiment, the substrate 50 is a glass plate having a smooth surface. The liquid bearing layer 52 and the pressure layer 54 are made of polydimethylsiloxane (PDMS). However, the materials used in the present invention should not be limited. Materials other than the aforesaid materials may be used according to the present invention. The thickness of the liquid bearing layer 52 is smaller than that of the pressure layer 54.

The substrate layer 50 is substantially flat. The liquid bearing layer 52 is also flat and is superimposed over the substrate layer 50. The liquid bearing layer 52 includes three spaced apart first injection holes 523 which extend through top and bottom surfaces 521, 522 of the liquid bearing layer 52, a first collection chamber 542 which extends through the top and bottom surfaces 521, 522, three microchannels 525, and a co-flow channel 526. The microchannels 525 are connected respectively to the first injection holes 523 and extend toward the collection chamber 542. The co-flow channel 526 has an upstream end connected to all of the microchannels 525 and a downstream end connected to the collection chamber 542. One of the microchannels 525 is arranged to be disposed between the other two of the microchannels 525. Each microchannel 525 has a cross-section smaller than that of the co-flow channel 526. The microchannels 525 and the co-flow channel 526 extend through the bottom surface 522 and are covered by the substrate layer 50. The microchannels 525 and the co-flow channel 526 do not penetrate the top surface 521.

The pressure layer 54 is substantially flat and is superimposed over the liquid bearing layer 52. The pressure layer 54 includes three spaced apart second injection holes 541 which extend through top and bottom surfaces 543 and 544 of the pressure layer 54 and which are aligned and communicated with the respective first injection holes 523, a second collection chamber 542 which extends through the top and bottom surfaces 543 and 544 and which is aligned and communicated with the first collection chamber 5, a pressure inlet/outlet hole 545, a pressure supply channel 546, and a pressurizing channel unit 547. The pressure inlet/outlet hole 545 extends through the top and bottom surfaces of the pressure layer 54. The pressure supply channel 546 and the pressurizing channel unit 547 extend only through the bottom surface of the pressure layer 54 and are covered by the liquid bearing layer 52.

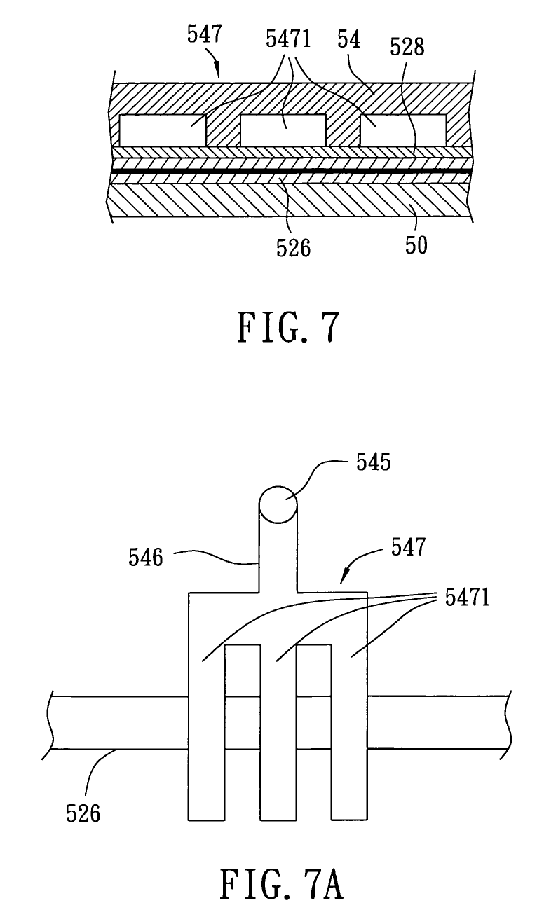

The pressurizing channel unit 547 includes a plurality of substantially parallel pressurizing channels 5471 (see FIGS. 7 and 7A) formed in the pressure layer 54. The pressurizing channels 5471 extend transversely of and over the co-flow channel 526 formed in the liquid bearing layer 52. As the pressurizing channels 5471 extend through the bottom surface 544 of the pressure layer 54 and as the co-flow channel 526 does not extend through the top surface 521 of the liquid bearing layer 52, the liquid bearing layer 52 has a membrane 528 (see FIG. 7) above the co-flow channel 526 or between the pressurizing channels 5471 and the co-flow channel 526. The membrane 528 cooperates with the pressurizing channels 5471 to constitute a comminuting member for comminuting a continuous phase liquid and a dispersed phase liquid. The membrane 528 is resilient and deflectable.

The chip device 500 may be used for producing microparticles for a liquid. In use, the second injection holes 541 in the pressure layer 54 are connected to liquid storage tanks (not shown) and the pressure inlet/outlet hole 545 is connected to an air compressor (not shown) for supplying or withdrawing a compressed gas to or from the pressure supply channel 546 and the pressurizing channels 5471. The first and second collection chambers 524 and 542 are connected to an external collection tube (not shown). The purpose of providing a larger thickness for the pressure layer 54 is to facilitate connection with a piping system and to avoid leakage of gas and/or liquid.

A method of producing microparticles according to the present invention primarily includes a first step in which a continuous phase liquid and a dispersed phase liquid are allowed to flow together through a co-flow channel, and a second step in which the dispersed phase liquid is comminuted into microparticles by intermittently moving a comminuting member transversely into the co-flow channel while the continuous phase and dispersed phase liquids flow through the co-flow channel.

In a preferred embodiment, the chip device 500 is used to produce the microparticles. The dispersed phase liquid is fed from the corresponding liquid storage tank (not shown) into the corresponding second and first injection holes 541 and 523 and is thereafter directed into one of the microchannels 525 which is interposed between the other two microchannels 525. The continuous phase liquid is fed from the corresponding liquid storage tank to the other two microchannels 525 through the respective second and first injection holes 541 and 523.

Referring to FIG. 6, as the three microchannels 525 are merged into the co-flow channel 526, the stream of the dispersed phase liquid is sandwiched by two streams of the continuous phase liquid when the continuous phase and dispersed phase liquids enter the co-flow channel 526. Therefore, the dispersed phase liquid is caused to flow within the flowing body of the continuous phase liquid in the co-flow channel 526.

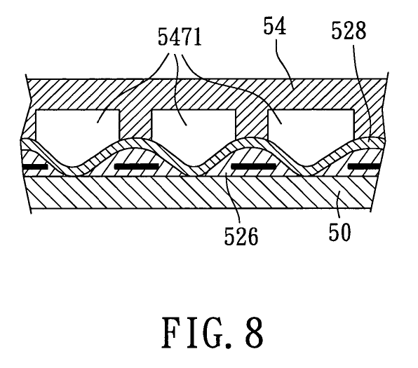

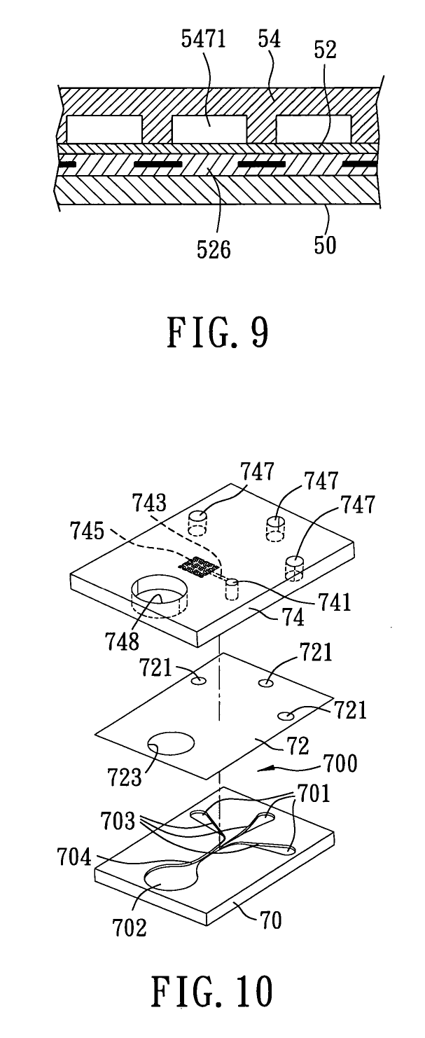

Referring to FIGS. 7, 8 and 9, the continuous phase and dispersed phase liquids flow in the co-flow channel 526 below the membrane 528 and the pressurizing channels 5471 of the comminuting member. When compressed air is forced into the pressurizing channels 5471 through the pressure inlet/outlet hole 545 and the pressure supply channel 546, the pressure in the pressurizing channels 5471 is increased so that the membrane 528 of the liquid bearing layer 52 is pressurized and moved into the co-flow channel 526 in a direction transverse to the co-flow channel 526, as shown in FIG. 8. At a result, the flowing stream of the continuous phase and dispersed phase liquids is comminuted into segments. When the pressure in the pressurizing channels 5471 is decreased, the membrane 528 is depressurized so that it moves outward from the co-flow channel 526 and returns to its original position, as shown in FIG. 9. The repeatedly increasing and decreasing the pressure of the pressurizing channels 5471 and the repetitive inward and outward movements of the membrane 528 can produce microparticles of the dispersed phase liquid which is dispersed in the continuous phase liquid of course, a surface-active agent should be added to one of the continuous phase liquid and the dispersed phase liquid in order to form and stabilize the microparticles. The microparticles as produced are collected in the first and second collection chambers 524 and 542.

While the flowing stream inside the co-flow channel 526 is comminuted by the membrane 528 which is actuated by the pressurizing channels 5471, the present invention should not be limited only thereto. The number of the pressurizing channels 5471 may be varied as desired. Furthermore, it is possible to use a single pressurizing channel in the present invention if the speed of the comminuting action of the membrane 528 is increased. Moreover, the flowing stream of the dispersed phase liquid may also be comminuted by any other suitable comminuting means which can move into the co-flow channel 526 to divide the flowing stream inside the co-flow channel 526.

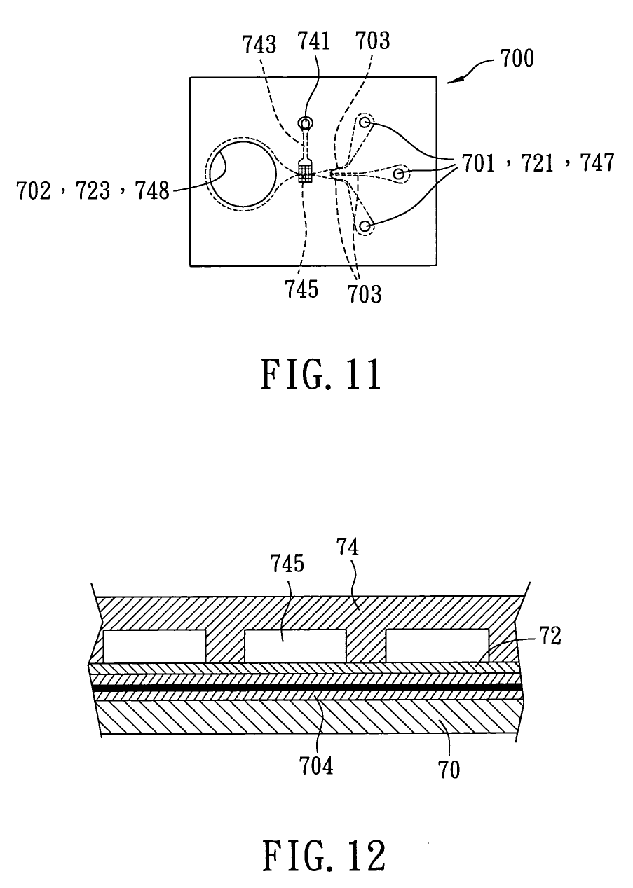

Referring to FIGS. 10, 11 and 12, there is shown a chip device 700 according to another preferred embodiment of the present invention. The chip device 700 includes a liquid bearing layer 70, a pressure layer 74, and an intermediate layer 72 disposed between the liquid bearing layer 70 and the pressure layer 74.

Unlike the liquid bearing layer 52 of the previous embodiment, the liquid bearing layer 70 in this embodiment has injection holes 701, microchannels 703, a co-flow channel 704 and a collection chamber 702 all of which extend through the top surface of the liquid bearing layer 70 but do not extend through the bottom surface thereof.

The pressure layer 74 of this embodiment is similar in construction to the pressure layer 54 of the previous embodiment, and includes a pressure inlet/outlet hole 741, a pressure supply channel 743, a pressurizing channel unit 745, injection holes 747, and a collection chamber 748.

The intermediate layer 72 is a membrane and includes three small holes which are respectively aligned and communicated with the injection holes 701 of the liquid bearing layer 70 and with the injection holes 747 of the pressure layer 74, and a large hole 723 which is aligned and communicated with the collection chamber 702 of the liquid bearing layer 70 and the collection chamber 748 of the pressure layer 74.

The comminuting member in this embodiment is formed by the pressurizing channel unit 745 and a membrane portion of the intermediate layer 72 that is interposed between the pressurizing channel unit 745 and the co-flow channel 704.

As described above, the method of producing microparticles according to the present invention is simple and may be performed using a simple chip device of the present invention which does not require a large size high pressure supply system to operate the chip device 500, 700. Furthermore, the chip device 500, 700 may be constructed easily at low costs. By controlling the flow rates within the microchannels 525, 703, and by controlling the frequency of pressure changes inside the pressurizing channel unit 547, 745, the size of the microparticles produced by the chip device 500, 700 may be varied as desired.

### EXAMPLE

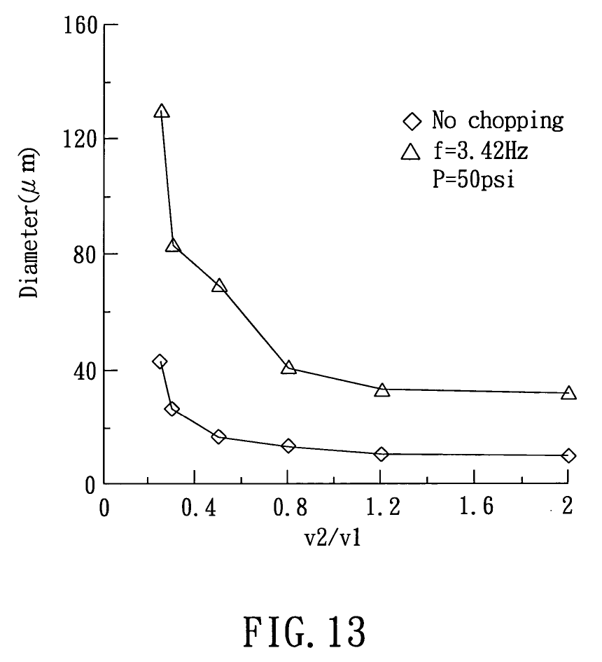

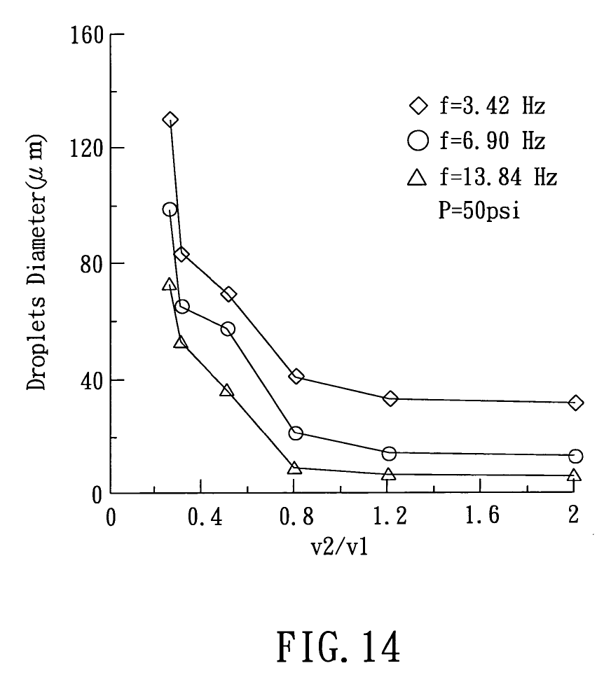

The chip device 500 is used to produce Vitamin C (dispersed phase liquid) microparticles dispersed in ethylhexyl thioglycolate (Trioctanoin) (EHTG, the continuous phase liquid). Ethylhexyl thioglycolate is mixed with a surfactant, DGL (PEG-10 polyglyceryl-2-laurate) in a ratio of 10:1. Vitamin C and ethylhexyl thioglycolate are controlled to flow in the microchannels 525 at predetermined rates. An airflow at a pressure of 50 psi is supplied to the pressurizing channel unit 547 through the pressure inlet/out hole 545. An electromagnetic valve is controlled by a frequency controller such that the pressure in the pressurizing channel unit 547 is increased and decreased at a predetermined frequency and the flowing stream inside the co-flow channel 526 is comminuted at a predetermined frequency. FIGS. 13 and 14 are diagrams which show varying sizes of the microparticles produced in this example at different frequencies and different ratios of the flow rates of the continuous and dispersed phase liquids. V₂ represents the flow rate of Vitamin C, whereas V₁ represents the flow rate of EHTG.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

We claim:

1. A method of producing microparticles, comprising:
(a) allowing a continuous phase liquid and a dispersed phase liquid to flow together through a co-flow channel; and
(b) intermittently comminuting the continuous phase and dispersed phase liquids by intermittently moving a comminuting member transversely into the co-flow channel.

2. The method of claim 1, further comprising (c) causing the dispersed phase liquid to flow within a flowing body of the continuous phase liquid in the co-flow channel.

3. The method of claim 2, wherein the step (c) includes:
providing at least two streams of the continuous phase liquid and at least one stream of the dispersed phase liquid upstream of the co-flow channel; and
causing the two streams of the continuous phase liquid to sandwich the stream of the dispersed phase liquid when the continuous phase and dispersed phase liquids enter the co-flow channel.

4. The method of claim 2, further comprising providing a collection chamber for collecting the microparticles at a downstream end of the co-flow channel.

5. A chip device for producing microparticles, comprising:
a co-flow channel adapted to permit a continuous phase liquid and a dispersed phase liquid to flow together therein and having an upstream end and a downstream end;
a plurality of microchannels adapted to direct the continuous phase liquid and the dispersed phase liquid to flow into said co-flow channel, all of said microchannels being connected to said upstream end of said co-flow channel; and
a comminuting unit disposed transversely of said co-flow channel and being operable to intermittently move into said co-flow channel in a direction transverse to said co-flow channel, whereby the dispersed phase liquid can be comminuted into microparticles.

6. The chip device of claim 5, further comprising a collection chamber connected to a downstream end of said co-flow channel.

7. The chip device of claim 5, wherein the number of said microchannels is three, one of said microchannels being arranged between the other two of said microchannels.

8. The chip device of claim 7, further comprising a liquid bearing layer, and a pressure layer superimposed over said liquid bearing layer, said microchannels and said co-flow channel being provided in said liquid bearing layer.

9. The chip device of claim 8, wherein said comminuting unit includes at least one pressurizing channel formed in said pressure layer and extending transversely over said co-flow channel, and a membrane extending between said pressurizing channel and said co-flow channel and operable by the pressure in said pressurizing channel to extend intermittently into said co-flow channel.

10. The chip device of claim 8, wherein said comminuting unit includes a plurality of substantially parallel pressurizing channels formed in said pressure layer and extending transversely over said co-flow channel, and a membrane extending between said pressurizing channels and said co-flow channel, said membrane being operable by the pressure in said pressurizing channels to extend intermittently into said co-flow channel.

11. The chip device of claim 10, wherein said pressure layer further includes a pressure inlet/outlet hole, and a pressure supply channel connected to said pressure inlet/outlet hole and said pressurizing channels.

12. The chip device of claim 11, wherein said liquid bearing layer further includes a collection chamber connected to a downstream end of said co-flow channel.

13. The chip device of claim 12, wherein said pressure layer further includes a collection chamber communicated with said collection chamber of said liquid bearing layer.

14. The chip device of claim 13, where in said liquid bearing layer further includes three injection holes connected respectively to said microchannels opposite to said co-flow channel.

15. The chip device of claim 14, wherein said pressure layer further includes three injection holes respectively communicated with said injection holes of said liquid bearing layer.

16. The chip device of claim 8, wherein said pressure layer and said liquid bearing layer are made of polydimethylsiloxane.
